(19) United States
(12) Patent Application Publication
(10) Pub. No.: US 2018/0112759 A1
(43) Pub. Date: Apr. 26, 2018

(54) DIFFERENTIAL DEVICE AND METHOD OF ASSEMBLING THE SAME

(71) Applicant: MUSASHI SEIMITSU INDUSTRY CO., LTD., TOYOHASHI-SHI (JP)

(72) Inventor: Yoichi YANASE, TOYOHASHI-SHI (JP)

(21) Appl. No.: 15/726,894

(22) Filed: Oct. 6, 2017

(30) Foreign Application Priority Data
Oct. 21, 2016 (JP) 2016-207349

(51) Int. Cl. F16H 48/40; F16H 48/08

(52) U.S. Cl. CPC F16H 48/40; F16H 2048/382; F16H 48/08

(57) ABSTRACT

In a differential device where sleeves passing through a differential case are connected with side gears and a washer is disposed between a back face of the side gear and an inner surface of the case facing each other, at least one of the side gears includes a shaft portion extending axially outwardly from the back face, the shaft portion and an inner peripheral surface of the sleeve being coupled together through a press-fit coupling. The one side gear has a washer support portion at a root of the shaft portion, the washer support portion having an outer peripheral surface in which an inner peripheral portion of the washer is fitted, and having an axial end face against which an end face on a front side in a press-fitting direction of the sleeve abuts or which the end face faces across a gap smaller than a thickness of the washer.

### BACKGROUND OF THE INVENTION

### Field of the Invention

The present invention relates to a differential device, comprising: a differential case; pinion gears and a pair of side gears disposed in the differential case, the pinion gears and the side gears meshing with each other; and a washer disposed between a back face of the side gear and an inner surface of the differential case which face each other. The present invention also relates to a method of assembling the differential device.

### Description of the Related Art

Relative to the differential device, Japanese Patent Nos. 3751488 and 5404727, for example, each disclose an arrangement in which a shaft portion on a back face side of a side gear is extended to the outside of a differential case and a portion between the extended shaft portion and a transmission case is oil-tightly sealed, to thereby hermetically seal transmission oil inside the transmission case. In each of the arrangements disclosed in Japanese Patent Nos. 3751488 and 5404727, in order to avoid elongation of the side gear, a cylindrically-shaped sleeve (cylindrical member) is manufactured separately from the side gear and is thereafter coupled with the side gear to thereby enable the sleeve to function as the extended shaft portion.

In the differential device disclosed in Japanese Patent No. 3751488, however, the side gear and the sleeve are coupled and integrated with each other through “pressure welding” that represents a type of welding technique and that involves metal fusion in the two bonding surfaces. The technique, while achieving a high coupling strength, requires additional steps of applying specially high pressure to and heating the bonded portions of the side gear and the sleeve during the coupling process. Thus, there is a problem that the coupling process is complicated and involves increased cost.

Meanwhile, in the differential device disclosed in Japanese Patent No. 5404727, the side gear and the sleeve are coupled with each other by an adhesive. Therefore, it is possible to solve the problem with the technique disclosed in Japanese Patent No. 3751488 to some degree, but there is a problem that it is impossible to achieve the high coupling strength.

### SUMMARY OF THE INVENTION

The present invention has been achieved in view of the above-mentioned circumstances and it is a first object of the present invention to provide a differential device capable of easy coupling between a side gear and a sleeve with a high coupling strength and capable of precise supporting of a washer between a back face of the side gear and a differential case and it is a second object of the present invention to provide a method of assembling the differential device capable of enhancing assemblability of the differential device.

In order to achieve the object, according to a first feature of the present invention, there is provided a differential device, comprising: a differential case; pinion gears and a pair of side gears disposed in the differential case, the pinion gears and the side gears meshing with each other; a cylindrical sleeve passing through the differential case and connected with at least one of the side gears; and a washer disposed between a back face of a tooth portion of the one side gear and an inner surface of the differential case which face each other, wherein the one side gear includes a shaft portion extending axially outwardly from the back face, the shaft portion and an inner peripheral surface of the sleeve being coupled with each other through a press-fit coupling, and the one side gear has a washer support portion at a root of the shaft portion, the washer support portion having an outer peripheral surface thereof in which an inner peripheral portion of the washer is fitted, and the washer support portion having an axial end face thereof against which an end face on a front side in a press-fitting direction of the sleeve abuts or which the end face faces across a gap smaller than a wall thickness of the washer.

With the first feature, in the differential device, at least one of the side gears includes the shaft portion extending from the back face outwardly in the axial direction and the press-fit coupling is achieved between the shaft portion and the inner peripheral surface of the sleeve. Thus, coupling between the side gears and the sleeves can be performed relatively simply and with a high coupling strength, so that special pressurizing and heating steps that are required in the coupling by pressure welding can be eliminated to promote process simplification and cost reduction. Moreover, at least one of the side gears has the washer support portion at a root of the shaft portion. The washer support portion has the outer peripheral surface in which the inner peripheral portion of the washer is fitted, and has the axial end face against which the end face on the front side in the press-fitting direction of the sleeve abuts or which the end face faces across a gap smaller than the wall thickness of the washer. This arrangement allows the sleeve to be press-fitted and coupled to the shaft portion of the side gear with the washer supported by the washer support portion. The washer can thus be prevented from being wedged between the side gear and the sleeve during the performance of the press-fit coupling. After the press-fitting is completed, the end face of the sleeve abuts against the washer support portion or faces the washer support portion across a gap smaller than the washer wall thickness. Thus, the washer can never be wedged between the side gear and the sleeve and the washer can be precisely supported.

According to a second feature of the present invention, in addition to the first feature, the differential case has a through hole passing through and supporting the sleeve, the through hole having a recess formed at an inner end thereof, the sleeve has a protrusion capable of being engaged in the recess, and the washer support portion is received in the recess together with the protrusion.

With the second feature, the protrusion engaged in the recess can prevent the sleeve from being removed from the differential case. Additionally, the washer support portion is also received by the recess at the inner end of the through hole in the differential case. Interference of the washer support portion with the differential case can be easily avoided without allowing the structure to be complicated.

According to a third feature of the present invention, there is provided a differential device, comprising: a differential case; pinion gears and a pair of side gears disposed in the differential case, the pinion gears and the side gears meshing with each other; a cylindrical sleeve passing through the differential case and connected with at least one of the side gears; and a washer disposed between a back face of a tooth portion of the one side gear and an inner surface of the differential case which face each other, wherein the one side gear includes a shaft portion extending axially outwardly from the back face, the shaft portion and an inner peripheral surface of the sleeve being coupled with each other through a press-fit coupling, and the sleeve includes a washer support portion disposed at an end portion on a front side in a press-fitting direction of the sleeve, the washer support portion having an outer peripheral surface thereof in which an inner peripheral portion of the washer is fitted, and the washer support portion having an axial end face thereof against which the back face of the one side gear abuts or which the back face faces across a gap smaller than a wall thickness of the washer.

With the third feature, in the differential device, at least one of the side gears includes the shaft portion extending from the back face outwardly in the axial direction and the press-fit coupling is achieved between the shaft portion and the inner peripheral surface of the sleeve. Thus, coupling between the side gears and the sleeves can be performed relatively simply and with a high coupling strength, so that special pressurizing and heating steps that are required in the coupling by pressure welding can be eliminated to promote process simplification and cost reduction. Moreover, the sleeve includes the washer support portion disposed at the front side in the press-fitting direction of the sleeve. The washer support portion has the outer peripheral surface in which the inner peripheral portion of the washer is fitted, and has the axial end face against which the back face of the side gear abuts or which the back face faces across a gap smaller than the wall thickness of the washer. This arrangement allows the sleeve to be press-fitted and coupled to the shaft portion of the side gear with the washer supported by the washer support portion. The washer can thus be prevented from being wedged between the side gear and the sleeve during the performance of the press-fit coupling. After the press-fitting is completed, the back face of the side gear abuts against the washer support portion or faces the washer support portion across a gap smaller than the washer wall thickness. Thus, the washer can never be wedged between the side gear and the sleeve and the washer can be precisely supported.

According to a fourth feature of the present invention, in addition to the third feature, the differential case has a through hole passing through and supporting the sleeve, the through hole having a recess formed at an inner end thereof, and the sleeve has a protrusion capable of being engaged in the recess, the protrusion being disposed to be adjacent to the washer support portion and to bulge radially outwardly further than the washer support portion.

With the fourth feature, the engagement of the protrusion in the recess can prevent the sleeve from being removed from the differential case. The protrusion as removal prevention means cooperates with the washer support portion to serve also as support steadying means for the washer. This steadies the support for the washer on the sleeve, while achieving a simplified structure.

According to a fifth feature of the present invention, there is provided a differential device, comprising: a differential case; pinion gears and first and second side gears disposed in the differential case, the pinion gears and the first and second side gears meshing with each other; cylindrical first and second sleeves respectively passing through first and second boss portions of the differential case and connected with the respective first and second side gears; and first and second washers respectively disposed between back faces of tooth portions of the first and second side gears and an inner surface of the differential case which face each other, wherein the first and second side gears respectively include shaft portions extending axially outwardly from the back faces, the shaft portions and inner peripheral surfaces of the first and second sleeves being coupled with each other through press-fit couplings, a first washer support portion and a first protrusion are provided at an end portion on a front side in a press-fitting direction of the first sleeve so as to be axially adjacent to each other, the first washer support portion having an outer peripheral surface thereof in which an inner peripheral portion of the first washer is fitted, the first washer support portion having an axial end face thereof against which the back face of the first side gear abuts or which the back face faces across a gap smaller than a wall thickness of the first washer, and the first protrusion bulging radially outwardly further than the first washer support portion, and the second side gear has a second washer support portion at a root of the shaft portion of the second side gear, the second washer support portion having an outer peripheral surface thereof in which an inner peripheral portion of the second washer is fitted, and the second washer support portion having an axial end face thereof against which an end face on a front side in a press-fitting direction of the second sleeve abuts or which the end face faces across a gap smaller than a wall thickness of the second washer.

With the fifth feature, the effects achieved by the first and third features described above can be achieved. Additionally, the first sleeve is press-fitted and coupled to the shaft portion of the first side gear under a condition in which the first washer is placed and held on the first protrusion of the first sleeve and the second sleeve is press-fitted and coupled to the shaft portion of the second side gear under a condition in which the second washer is placed and held on the back face of the second side gear. Thus, the first and second side gears, the first and second sleeves, and the first and second washers can be assembled in the differential case quickly, while a predetermined holding attitude of the differential case is maintained without having to turn upside down the differential case during the assembly work.

According to a sixth feature of the present invention, there is provided a method of assembling the differential device according to claim 5, comprising at least: a case holding step of holding the differential case such that the second boss portion is on an upper side and the first boss portion is on a lower side; a first sleeve assembling step of assembling the first sleeve in the differential case; a first washer attaching step of fitting the first washer in the first washer support portion of the first sleeve and placing the first washer on the first protrusion; a first side gear assembling step of assembling the first side gear in the differential case so as to be adjacent to an upper portion of the first sleeve; a first sleeve press-fitting step of coupling the inner peripheral surface of the first sleeve with the shaft portion of the first side gear through the press-fit coupling; a second sleeve assembling step of assembling the second sleeve in the differential case; a second washer attaching step of fitting the second washer in the second washer support portion of the second side gear and placing the second washer on the back face of the second side gear; a second side gear assembling step of assembling the second side gear in the differential case so as to be adjacent to a lower portion of the second sleeve; and a second sleeve press-fitting step of coupling the inner peripheral surface of the second sleeve with the shaft portion of the second side gear through the press-fit coupling.

With the sixth feature, in the assembly processes of the differential device having the fifth feature, the first and second side gears, the first and second sleeves, and the first and second washers can be assembled in the differential case quickly, while a predetermined holding attitude of the differential case is maintained without the need to turn upside down the differential case during the assembly work. This contributes to improved workability.

The above and other objects, characteristics and advantages of the present invention will be clear from detailed descriptions of the preferred embodiments which will be provided below while referring to the attached drawings.

### BRIEF DESCRIPTION OF THE DRAWINGS

FIG. 1 is a sectional view of a differential device according to a first embodiment of the present invention.

FIG. 2 is a sectional view taken along line 2-2 in FIG. 1.

FIGS. 3A to 3C are sectional views for schematically illustrating an assembly process for the differential device (particularly a step of inserting a first side gear and a first sleeve into a differential case and press-fitting and coupling the first side gear and the first sleeve to each other), FIG. 3A depicting a condition in which the first sleeve and a first washer are positioned in a first boss portion of the differential case, FIG. 3B depicting a condition in which the first side gear is placed on the first sleeve, and FIG. 3C depicting a condition in which from the condition of FIG. 3B, the first sleeve is press-fitted and coupled to a shaft portion of the first side gear.

FIGS. 4A and 4B are sectional views for schematically illustrating an assembly process for the differential device (particularly a step of inserting a second side gear and a second sleeve into the differential case and press-fitting and coupling the second side gear and the second sleeve to each other), FIG. 4A depicting a condition in which the second sleeve is positioned in a second boss portion of the differential case and a second washer and the second side gear are positioned below the second sleeve and FIG. 4B depicting a condition in which from the condition of FIG. 4A, the second sleeve is press-fitted and coupled to a shaft portion of the second side gear.

FIG. 5 is a sectional view for schematically illustrating an assembly process for the differential device (particularly a step of installing a pinion gear in the differential case), FIG. 5 depicting a condition in which the pinion gear is placed, through access windows of the differential case, at a position at which the pinion gear meshes with the first side gear and the second side gear.

FIGS. 6A to 6C are sectional views for schematically illustrating an assembly process for a differential device according to a second embodiment of the present invention, FIG. 6A depicting a condition in which a first side gear, a first sleeve, and a first washer are positioned in a differential case, FIG. 6B depicting a condition in which a second side gear, a second sleeve, and a second washer are positioned in the differential case, FIG. 6C depicting a condition immediately after a step of press-fitting and coupling the first side gear and the first sleeve to each other and a step of press-fitting and coupling the second side gear and the second sleeve to each other are performed at once after the condition of FIG. 6B.

FIGS. 7A to 7C are sectional views (corresponding to FIG. 6C) for schematically illustrating variations of a sleeve press-fitting step in the assembly process for the differential device according to the second embodiment of the present invention, FIG. 7A depicting variation 1, FIG. 7B depicting variation 2, FIG. 7C depicting variation 3.

### DESCRIPTION OF THE PREFERRED EMBODIMENTS

Embodiments of the present invention will be described below with reference to the accompanying drawings.

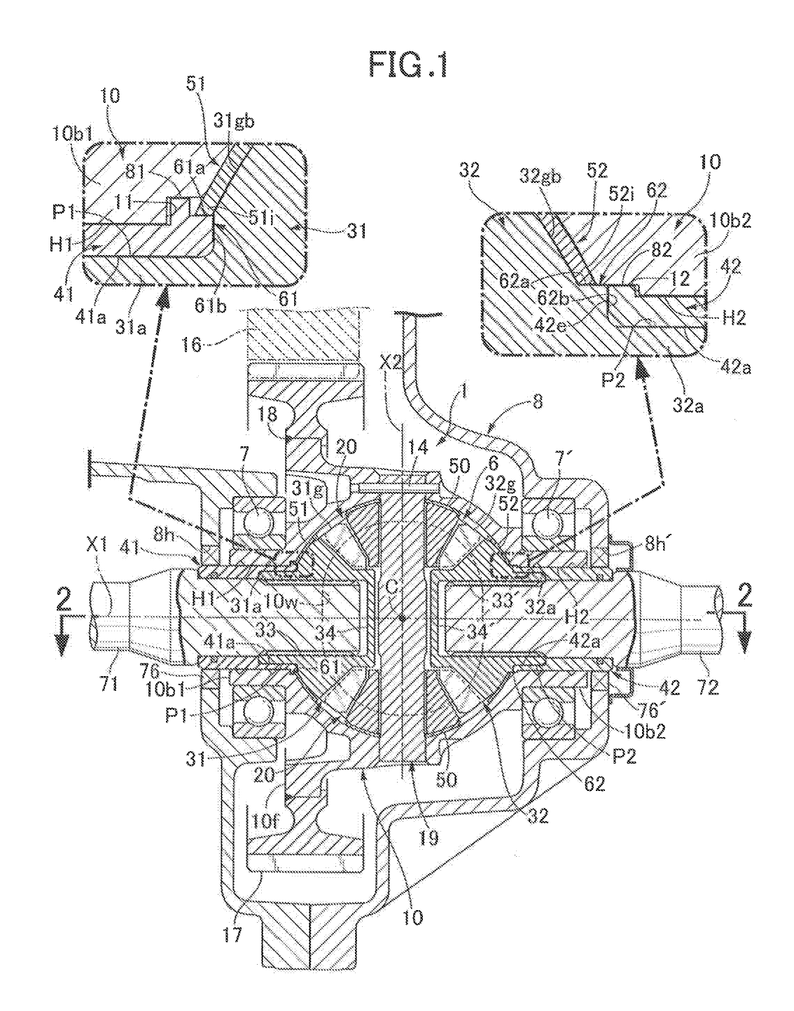

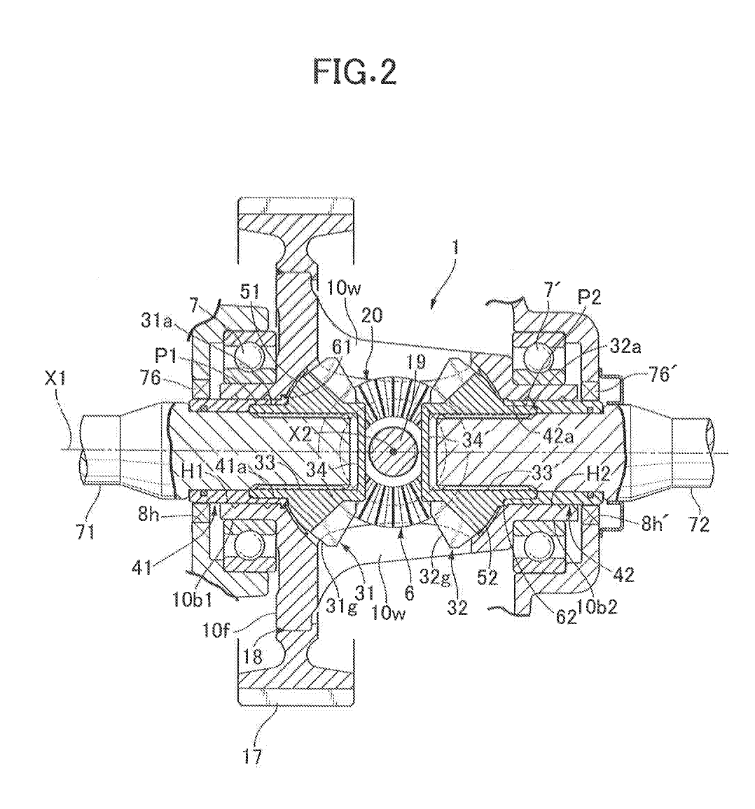

Reference is made to FIGS. 1 and 2. A transmission case 8 of an automobile houses a differential device 1 together with a transmission device not depicted. The differential device 1 includes a differential case 10 and a differential gear mechanism 6. The differential case 10 is formed of a single seamless member. The differential gear mechanism 6 is incorporated in the differential case 10. A cylindrical first boss portion 10b1 and a cylindrical second boss portion 10b2 are integrally formed with the differential case 10. The first boss portion 10b1 is disposed on one side wall (left side wall in FIG. 1) of the differential case 10. The second boss portion 10b2 is disposed on an opposite side wall (right side wall in FIG. 1) of the differential case 10. The first boss portion 10b1 and the second boss portion 10b2 are disposed to be spaced apart from each other on a first axis X1 as a rotational axis of the differential case 10. The differential case 10 is supported rotatably by the transmission case 8 via bearings 7 and 7′ at the first boss portion 10b1 and the second boss portion 10b2.

The differential case 10 has an annular flange 10f integrally formed therewith. The flange 10f is formed on a peripheral wall of the differential case 10, the peripheral wall being offset on the first boss portion 10b1 side from a center C of the differential case 10. A ring gear 17 that meshes with an output gear 16 of the transmission device that is coupled with a power source is fixed by fixing means to the flange 10f. As the fixing means, bolting, crimping, or any other fixing means may be selected as appropriate, in addition to welding 18 as in the illustrated example. It is noted that the ring gear may be integrally formed with the differential case 10 without the use of any of the above fixing means.

The differential gear mechanism 6 includes a pinion shaft 19, a pair of pinion gears 20, and a pair of first and second side gears 31 and 32. The pinion shaft 19 is disposed on a second axis X2 that is orthogonal to the first axis X1. The pinion shaft 19 is held in the differential case 10 so as to pass through the center C of the differential case 10. The pinion gears 20 are supported on opposite ends of the pinion shaft 19 rotatably about the second axis X2. The first and second side gears 31 and 32 are disposed so as to sandwich each of the pinion gears 20 and mesh with each of the pinion gears 20. The pinion gears 20 and the first and second side gears 31 and 32 are each a bevel gear and are incorporated together with the pinion shaft 19 in the differential case 10.

The differential case 10 has an inner surface formed spherically and equidistantly from the center C. Additionally, a tooth portion of the pinion gear 20 has a back face opposed to the differential case 10. Mutually opposing surfaces of the back face of the tooth portion of the pinion gear 20 and the differential case 10 are spherical and a spherical washer 50 is disposed between the mutually opposing surfaces.

The pinion shaft 19 is fixed to the differential case 10 by a lock pin 14 that is press-fitted in the differential case 10. It is noted that the lock pin 14 may be fixed in position by any means (e.g., welding and screwing) other than press-fitting.

The first and second side gears 31 and 32 integrally include tooth portions 31g and 32g and shaft portions 31a and 32a that extend outwardly in an axial direction from back faces 31gb and 32gb of the tooth portions 31g and 32g. Mutually opposing surfaces of each of the back faces 31gb and 32gb of the tooth portions 31g and 32g and the differential case 10 are also spherical. First and second washer 51 and 52 are disposed between the mutually opposing surfaces, respectively.

Inner peripheral surfaces of cylindrical first and second sleeves 41 and 42 that respectively pass through holes H1 and H2 of the first and second boss portions 10b1 and 10b2 of the differential case 10 are coupled with outer peripheral surfaces of the shaft portions 31a and 32a of the first and second side gears 31 and 32 by press-fit couplings P1 and P2, respectively. The press-fit coupling P1 and P2 integrally couples the first and second sleeves 41 and 42 with the first and second side gears 31 and 32, respectively.

The first and second sleeves 41 and 42 in the first embodiment have annular recesses 41a and 42a in inner peripheral surfaces at inner end portions of the first and second sleeves 41 and 42. The annular recesses 41a and 42a are capable of receiving the shaft portions 31a and 32a. The outer peripheral surface of the shaft portions 31a and 32a are press-fitted into the annular recesses 41a and 42a, respectively. Hence, the first and second sleeves 41 and 42 function as extended shafts of the shaft portions 31a and 32a and are rotatably fitted and supported, together with the shaft portions 31a and 32a, in the through holes H1 and H2 in the respective first and second boss portions 10b1 and 10b2 of the differential case 10.

The first and second side gears 31 and 32 have central holes 33 and 33′ that axially pass through central portions of the tooth portions 31g and 32g and the shaft portions 31a and 32a. One end sides of the central holes 33 and 33′ are connected and flush with the inner peripheral surfaces of the first and second sleeves 41 and 42 and opposite end sides of the central holes 33 and 33′ are closed by closing walls 34 and 34′ that are integrally formed with axial inner end portions of the tooth portions 31g and 32g. It is noted that the closing walls 34 and 34′ may be formed by cap members formed separately from the tooth portions 31g and 32g and attached oil-tightly to the tooth portions 31g and 32g later.

Inner end portions of first and second drive shafts 71 and 72 are respectively inserted from axial outward directions into inner peripheral surfaces of the central holes 33 and 33′ of the first and second side gears 31 and 32 and the first and second sleeves 41 and 42. In particular, the central holes 33 and 33′ and the inner end portions of the first and second drive shafts 71 and 72 are spline-fitted to each other. This arrangement results in the first and second side gears 31 and 32 and the first and second drive shafts 71 and 72 integrally rotating about the first axis X1 in operative connection with each other. Additionally, outer end sides of the first and second drive shafts 71 and 72 are operatively connected with left and right axles not depicted.

The first and second drive shafts 71 and 72 are inserted into the transmission case 8 through a pair of through holes 8h and 8h′ formed in the transmission case 8. Annular sealing members 76 and 76′ are disposed between inner surfaces of the through holes 8h and 8h′ and outer peripheral surfaces of the first and second sleeves 41 and 42, respectively.

Thus, a rotational driving force from the power source (transmission device), which has been input to the differential case 10, is transmitted to the first and second side gears 31 and 32 via the pinion shaft 19 and the pinion gears 20 and further to the first and second drive shafts 71 and 72. The first and second drive shafts 71 and 72 are thereby rotated, while being allowed for differential rotation. The following details a mounting and support structure for the first and second washers 51 and 52 that support the back faces 31gb and 32gb of the first and second side gears 31 and 32.

A first washer support portion 61 and a first protrusion 81 are integrally provided with an inner end portion (that is, an end portion on a front side in the press-fitting direction) of the first sleeve 41 so as to be adjacent to each other in the axial direction. The first washer support portion 61 has an outer peripheral surface 61a to which an inner peripheral portion 51i of the first washer 51 is fitted, the first washer support portion 61 having an axial end face 61b against which the back face 31gb of the first side gear 31 abuts. The first protrusion 81 bulges outwardly in the radial direction further than the first washer support portion 61.

The through hole H1 in the first boss portion 10b1 of the differential case 10 has an annular first recess 11 at an inner end portion thereof in the axial direction. The first recess 11 is open toward the center C side of the differential case 10. The first recess 11 receives the first protrusion 81, the first washer support portion 61, and the inner peripheral portion 51i of the first washer 51. Thus, engagement between the first recess 11 and the first protrusion 81 prevents the first sleeve 41 fitted and inserted into the through hole H1 in the differential case 10 from being removed toward the outside in the axial direction. Specifically, the first protrusion 81 functions as a locking protrusion for the first sleeve 41.

Meanwhile, the through hole H2 in the second boss portion 10b2 of the differential case 10 has an annular second recess 12 at an inner end portion thereof in the axial direction. The second recess 12 is open toward the center C side of the differential case 10. A second protrusion 82 is formed integrally with an outer periphery of an inner end portion (that is, an end portion on a front side in the press-fitting direction) of the second sleeve 42. The second protrusion 82 is able to be engaged in the second recess 12. Thus, the engagement between the second recess 12 and the second protrusion 82 prevents the second sleeve 42 fitted and inserted into the through hole H2 in the differential case 10 from being removed toward the outside in the axial direction. That is, the second protrusion 82 functions as a locking protrusion for the second sleeve 42.

The second side gear 32 has a second washer support portion 62 integrated therewith in a protruding condition at a root of the shaft portion 32a thereof. The second washer support portion 62 is formed in an annular stepped shape that protrudes one step from an outer peripheral surface of the shaft portion 32a. The second washer support portion 62 has an outer peripheral surface 62a in which an inner peripheral portion 52i of the second washer 52 is fitted. The second washer support portion 62 further has an axial end face 62b against which an end face 42e of the inner end portion (that is, the end portion on the front side in the press-fitting direction) of the second sleeve 42 abuts. Hence, the second washer support portion 62 is received together with the second protrusion 82 of the second sleeve 42 by the second recess 12.

In addition, a peripheral wall of the differential case 10 is provided with a pair of access windows 10w so that the access windows 10w are placed symmetrically on opposite sides of the center C of the differential case 10, the center C being interposed between the access windows 10w. The access windows 10w permit work for machining the spherical inner surfaces of the differential case 10 and work for assembling different parts of the differential gear mechanism 6 in the differential case 10.

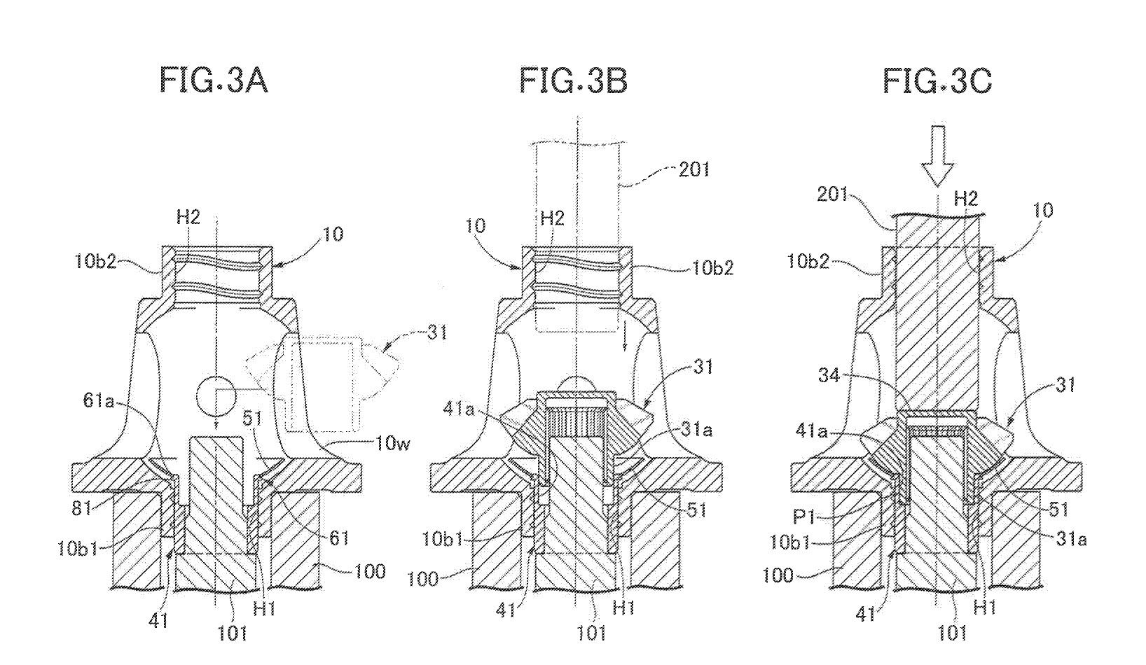

Operation in the first embodiment will be described below with reference to FIGS. 3A to 5, in addition.

When the differential device 1 is assembled, a case holding process is first performed. In the case holding process, the differential device 1 is held on a fixed case support base 100 such that, as depicted in FIGS. 3A to 3C, for example, the first boss portion 10b1 is on the lower side and the second boss portion 10b2 is on the upper side (more specifically, the differential case 10 is held in a stationary standing posture with an outer surface of the differential case 10 placed on an upper surface of the cylindrical case support base 100 and an outer peripheral surface of the first boss portion 10b1 fitted into an inner peripheral surface of the case support base 100). This standing posture is maintained also in the subsequent processes.

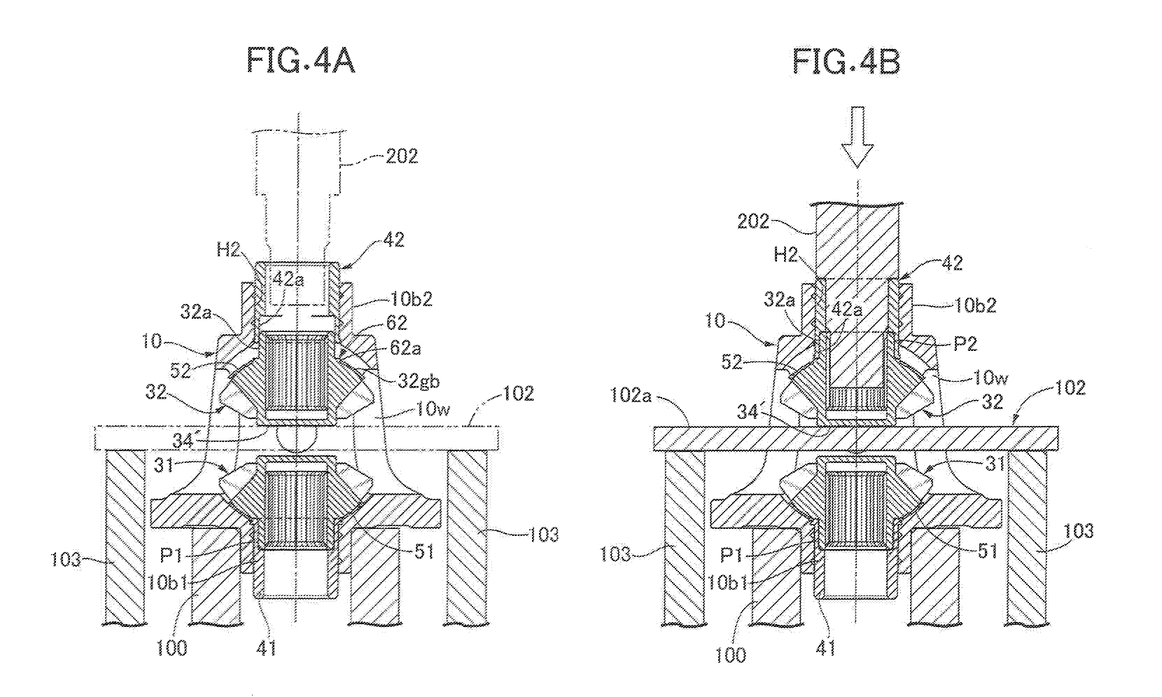

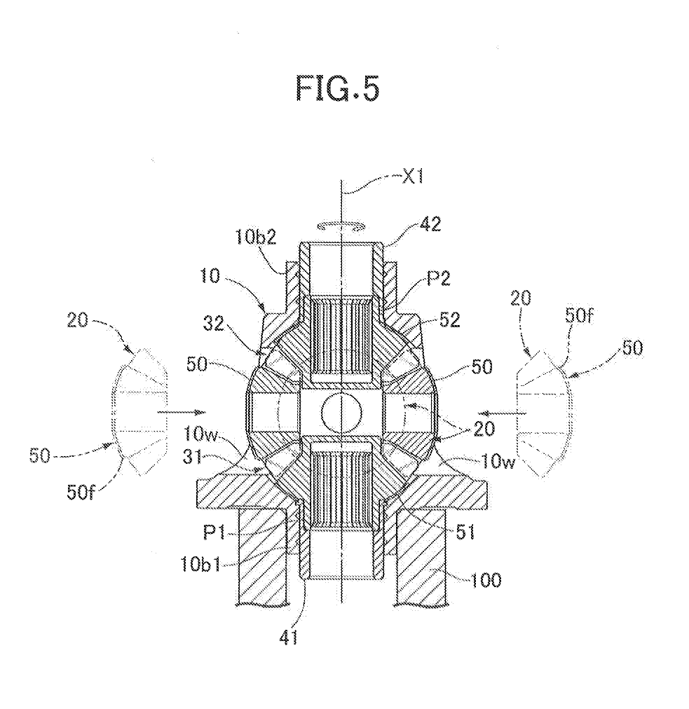

Subsequent processes are then performed in sequence. Specifically, the processes following the case holding process are: a First Side Gear Assembly Process (see FIGS. 3A to 3C), in which the first side gear 31 is coupled and integrated with the first sleeve 41 and is assembled to the differential case 10; a Second Side Gear Assembly Process (see FIGS. 4A and 4B), in which the second side gear 32 is coupled and integrated with the second sleeve 42 and is assembled to the differential case 10; and a Pinion Gear Assembly Process (see FIG. 5), in which the pinion gears 20 are assembled in the differential case 10 so as to be in mesh with the first side gear 31 and the second side gear 32.

A specific example of the First Side Gear Assembly Process will be described below with reference to FIGS. 3A to 3C.

Specifically, the First Side Gear Assembly Process includes a first sleeve assembly step, a first washer assembly step, a first side gear assembly step, and a first sleeve press-fitting step:

in the first sleeve assembly step (see FIG. 3A), the first sleeve 41 inserted into the differential case 10 through the access window 10w is fitted and inserted from the inward side of the differential case 10 downwardly into the through hole H1 in the first boss portion 10b1 of the differential case 10, so that the sleeve 41 is assembled into the first boss portion 10b1;

in the first washer assembly step (see FIG. 3A), the first washer 51 is fitted to the outer peripheral surface 61a of the first washer support portion 61 in the first sleeve 41 and is placed on the first protrusion 81;

in the first side gear assembly step (see FIG. 3B), the first side gear 31 inserted into the differential case 10 through the access window 10w is assembled in the differential case 10 so as to be adjacent to the upper portion of the first sleeve 41 (more specifically, such that a tip end of the shaft portion 31a of the first side gear 31 is fitted to an upper end portion of the first sleeve 41, that is, an inner peripheral surface of the annular recess 41a); and

in the first sleeve press-fitting step (see FIG. 3C), the press-fit coupling P1 is performed, as depicted in FIG. 3C, between the shaft portion 31a of the first side gear 31 and the inner peripheral surface of the annular recess 41a in the first sleeve 41.

In the above, the first sleeve assembly step and the first washer assembly step may be performed in reverse order.

In the first sleeve assembly step, the lower end of the first sleeve 41 is engaged with and supported by a stepped portion on an outer periphery of a first sleeve support base 101 having a stepped cylindrical tip portion. This engagement with support defines a lower limit (that is, a predetermined support position) for the first sleeve 41. The definition of the lower limit results in the first washer 51 on the first sleeve 41 being held at a position spaced apart from the inner surface (that is, a thrust bearing surface) of the differential case 10. It is noted that the first sleeve support base 101 is held in a stationary position at the sleeve support position depicted in FIGS. 3A to 3C until the first sleeve press-fitting step is completed. After the first sleeve press-fitting step has been completed, the first sleeve support base 101 is driven to lower by support base drive means not depicted to thereby be spaced away from the first sleeve 41. As a result, a connected body of the first sleeve 41 and the first side gear 31 subassembly lowers by its own weight until the first washer 51 abuts against the inner surface of the differential case 10.

In the first sleeve press-fitting step, the press-fit coupling P1 between the first side gear 31 and the first sleeve 41 is performed, in which as depicted in FIG. 3C, using a first side gear punch 201 capable of ascent/descent drive operation, the closing wall 34 on the upper end of the first side gear 31 is pressed toward the first sleeve 41 side (that is, downwardly) through the through hole H2 in the second boss portion 10b2 of the differential case 10. After the press-fit coupling P1 has been performed, the first side gear punch 201 is raised to be retracted from the differential case 10 before the Second Side Gear Assembly Process is next performed.

A specific example of the Second Side Gear Assembly Process will be described below with reference to FIGS. 4A and 4B.

Specifically, the Second Side Gear Assembly Process includes a second sleeve assembly step, a second washer assembly step, a second side gear assembly step, and a second sleeve press-fitting step:

in the second sleeve assembly step (see FIG. 4A), the second sleeve 42 inserted into the differential case 10 through the access window 10w is fitted and inserted from the inward side of the differential case 10 upwardly into the through hole H2 in the second boss portion 10b2 of the differential case 10, so that the second sleeve 42 is assembled into the second boss portion 10b2;

in the second washer assembly step (see FIG. 4A), the second washer 52 is fitted to the outer peripheral surface 62a of the second washer support portion 62 in the second side gear 32 and is placed on the back face 32gb of the second side gear 32;

in the second side gear assembly step (see FIG. 4A), the second side gear 32 assembled with the second washer 52 is inserted into the differential case 10 through the access window 10w and assembled into the differential case 10 so as to be adjacent to the lower portion of the second sleeve 42 (more specifically, such that a tip end of the shaft portion 32a of the second side gear 32 is fitted into a lower end portion of the second sleeve 42, that is, an inner peripheral surface of the annular recess 42a); and

in the second sleeve press-fitting step (see FIG. 4B), the press-fit coupling P2 is performed, as depicted in FIG. 4B, between the shaft portion 32a of the second side gear 32 and the inner peripheral surface of the annular recess 42a in the second sleeve 42.

In the above, the second sleeve 42 that has undergone the second sleeve assembly step is supported by, for example, hands of an assembly operator or a jig not depicted to thereby prevent the second sleeve 42 from falling from the second boss portion 10b2.

In the second sleeve press-fitting step, a second side gear support base 102 extending long in the horizontal direction is first inserted through the access window 10w into the differential case 10. The second side gear support base 102, which has been inserted in the differential case 10, is placed on and supported by a plurality of struts 103 that stand upright on opposite outer sides of the differential case 10. The closing wall 34′ on the lower end of the second side gear 32 is then abutted against an upper surface 102a of the second side gear support base 102, so that the second side gear 32 can be supported from below and prevented from free fall. It is noted that the struts 103 may be disposed at a position in a periphery of the case support base 100 only during the second sleeve press-fitting step and retracted from the peripheral position by using support drive means not depicted in other steps. Alternatively, the struts 103 may be left standing in the peripheral position unless the struts 103 are a hindrance to other steps.

Additionally, in the second sleeve press-fitting step, the press-fit coupling P2 between the second side gear 32 and the second sleeve 42 is performed, in which by using the second sleeve punch 202, the second sleeve 42 is pressed toward the second side gear 32 side (that is, downwardly) under a condition in which the second side gear 32 is supported by a second side gear support base 102. After the press-fit coupling P2 has been performed, the second side gear support base 102 is pulled out to be retracted from the differential case 10 before the Pinion Gear Assembly Process is next performed.

The second sleeve punch 202 has a stepped cylindrical tip portion and is moved up and down by ascent/descent drive means not depicted. The upper end of the second sleeve 42 is engaged with the stepped portion on the outer periphery of the tip portion.

When the second side gear support base 102 is retracted, hands of the assembly operator or a jig not depicted, for example, temporarily support the second side gear 32 to thereby avoid the second side gear 32 from falling to collide hard against the first side gear 31.

A specific example of the Pinion Gear Assembly Process will be described below with reference to FIG. 5.

Specifically, the Pinion Gear Assembly Process includes a washer assembly step, a pinion gear assembly step, and a pinion shaft fixing step.

In the washer assembly step (see the dash-single-dot line in FIG. 5), the washers 50 are placed concentrically on back faces of the tooth portions of the pair of pinion gears 20.

In the pinion gear assembly step, the pair of pinion gears 20 fitted with the washers 50 is inserted into the differential case 10 through the access windows 10w. The pair of pinion gears 20 is then meshed with the first side gear 31 and the second side gear 32 in a state where phases of the pinion gears 20 and the phases of the first and second side gears 31 and 32 are displaced from each other by 180 degrees (see the solid line in FIG. 5). The pair of pinion gears 20 is then revolved 90 degrees about the rotational axis X1 of the first side gear 31 and the second side gear 32 so as to be placed in predetermined positions (see the dash-double-dot line in FIG. 5).

In the pinion shaft fixing step, in order to fix in the differential case 10 the pinion shaft 19 that supports the pinion gears 20 placed in the predetermined positions, the pinion shaft 19 is inserted through the differential case 10 and the pinion gears 20 and the lock pin 14 that fixes the pinion shaft 19 is press-fitted into the differential case 10.

In the above washer assembly step, annular flanges 50f integrally connected with outer peripheral portions of the washers 50 are engaged with stepped portions of outer peripheries on the back faces of the tooth portions of the pinion gears 20. The washers 50 can thereby be easily fitted concentrically with the back faces of the pinion gears 20 and the foregoing fit condition can be maintained. Thus, during the pinion gear assembly step, too, the washers 50 can be precisely held on the back faces of the pinion gears 20 without allowing the concentric fit condition to collapse.

It is noted that, when the pinion gears 20 are meshed with the first side gear 31 and the second side gear 32 during the pinion gear assembly step, the upper second side gear 32, in particular, needs to be supported (that is, held up) by hands or a jig. The supporting is, however, no longer necessary after the meshing.

To install the differential device 1 assembled as described above in the transmission case 8, the differential case 10 is supported in the transmission case 8 via the bearings 7 and 7′ and spaces between the outer peripheral surfaces of the first boss portion 10b1 and the second boss portion 10b2 of the differential case 10, and the through holes 8h and 8h′ in the transmission case 8 are sealed by the annular sealing members 76 and 76′. Thereafter, the inner end portions of the first drive shaft 71 and the second drive shaft 72 are inserted in and spline-fitted to the central holes 33 and 33′ in the first side gear 31 and the second side gear 32.

In the First Side Gear Assembly Process and the Second Side Gear Assembly Process according to the first embodiment described above, the press-fit coupling P1 and the press-fit coupling P2 are performed between the shaft portions 31a and 32a of the first and second side gears 31 and 32 and the first and second sleeves 41 and 42, respectively, under a condition in which the first and second side gears 31 and 32 and the first and second sleeves 41 and 42 are assembled into the differential case 10. This approach enables coupling between the first and second side gears 31 and 32 and the first and second sleeves 41 and 42 relatively simply and with a high coupling strength, so that special pressurizing and heating steps that are required in the coupling by pressure welding can be eliminated to promote process simplification and cost reduction. In addition, even when the first and second sleeves 41 and 42 are long, the first and second sleeves 41 and 42 can be coupled with the first and second side gears 31 and 32 inside the differential case 10 without any hindrance.

Because the Pinion Gear Assembly Process is performed after the foregoing assembly processes have been completed, the pinion gears 20 is outside the differential case 10 when the press-fit couplings P1 and P2 are performed between the shaft portions 31a and 32a of the first and second side gears 31 and 32 and the first and second sleeves 41 and 42. The pinion gears 20 are assembled in the differential case 10 after the press-fit couplings P1 and P2 have been completed. Thus, press-fitting load (that is, coupling load) tends less to act on the meshing portions between the pinion gears 20 and the first and second side gears 31 and 32, so that deformation and damage of the meshing portions caused by the coupling load can be avoided.

In the first embodiment, in the step of performing the press-fit coupling P1 between the first side gear 31 and the first sleeve 41, the second side gear 32 is yet to be mounted in the differential case 10 and thus the pressing force of the first side gear punch 201 can be applied to the first side gear 31 through the through hole H2 in the second boss portion 10b2 of the differential case 10 (that is, without interfering with the second side gear 32 and the second sleeve 42). After such pressing, the first side gear punch 201 is retracted from the differential case 10 before the press-fit coupling P2 is performed between the second side gear 32 and the second sleeve 42. Thus, the first side gear punch 201 can never be a hindrance to the performance of the press-fit coupling P2.

In the press-fit coupling P1 between the first side gear 31 and the first sleeve 41, the first side gear punch 201 presses the first side gear 31 into the first sleeve 41 under a condition in which the first sleeve support base 101 passes through and supports both the first sleeve 41 and the first side gear 31. This approach allows the shaft portion 31a of the first side gear 31 to be precisely coupled with the first sleeve 41 by the press-fit coupling P1, while the first side gear 31 and the first sleeve 41 are coaxially supported by the first sleeve support base 101.

In the press-fit coupling P1 between the first side gear 31 and the first sleeve 41, the first side gear 31 is pressed toward the first sleeve 41 side under a condition in which the first sleeve 41 is supported at a predetermined support position (that is, height) by the first sleeve support base 101. The abovementioned predetermined support position is set such that the back face 31gb of the tooth portion 31g of the first side gear 31 can maintain a position spaced away from the inner surface (that is, thrust bearing surface) of the differential case 10 facing the back face 31gb during the press-fit coupling P1 of the first side gear 31 with the first sleeve 41. Thus, the press-fitting load does not act on the thrust bearing surface and the thrust bearing surface can be reliably prevented from being damaged by the press-fitting load. Moreover, in this case, the first side gear 31 is pressed toward the first sleeve 41 side, while having a portion (in the first embodiment, the closing wall 34) other than the tooth portion 31g of the first side gear 31 as a portion to bear the pressing force. Thus, the tooth portion 31g of the first side gear 31 can be reliably prevented from being damaged by the press-fitting load.

In the press-fit coupling P2 between the second side gear 32 and the second sleeve 42 according to the first embodiment, the second sleeve punch 202 that passes through and supports both the second side gear 32 and the second sleeve 42 presses the second sleeve 42 toward the second side gear 32 side. This approach enables the press-fit coupling P2 to be precisely performed between the shaft portion 32a of the second side gear 32 and the second sleeve 42, while the second sleeve punch 202 supports the second sleeve 42 and the second side gear 32 so that they are coaxial with each other.

The press-fit coupling P2 between the second side gear 32 and the second sleeve 42 is performed so that the second sleeve 42 is pressed toward the second side gear 32 side by the second sleeve punch 202 under a condition in which the second side gear 32 is supported by the second side gear support base 102 inserted inside the differential case 10. This approach enables the second side gear support base 102 to reliably bear the press-fitting load. Thus, there is no likelihood that the press-fitting load will act to damage the back face 31gb of the first side gear 31 that has been assembled in the differential case 10 in advance or the inner surface (that is, the thrust bearing surface) of the differential case 10 facing the back face 31gb. Additionally, the subsequent Pinion Gear Assembly Process is performed only after the second side gear support base 102 has been retracted from the differential case 10. The second side gear support base 102 thus can never be a hindrance to the performance of the Pinion Gear Assembly Process.

The access windows 10w in the differential case 10 in the first embodiment serve not only as insertion ports through which the first and second side gears 31 and 32 and the pinion gears 20 are inserted into the differential case 10, but also as insertion ports through which the second side gear support base 102 are inserted into the differential case 10. This achieves a simplified structure of the differential case 10.

The press-fit coupling P2 between the second side gear 32 and the second sleeve 42 is performed such that the second sleeve 42 is pressed toward the second side gear 32 side under a condition in which the second side gear support base 102 supports the second side gear 32 by a portion (in the first embodiment, the closing wall 34′) other than the tooth portion 32g of the second side gear 32. This approach reliably prevents the tooth portion 32g of the second side gear 32 from being damaged by the press-fitting load.

Additionally, in the first embodiment in particular, the first washer support portion 61 is integrally formed at the end portion on the front side in the press-fitting direction of the first sleeve 41. The first washer support portion 61 has the outer peripheral surface 61a to which the inner peripheral portion 51i of the first washer 51 is fitted, the first washer support portion 61 having the axial end face 61b against which the back face 31gb of the first side gear 31 abuts. This arrangement enables the press-fit coupling P1 to be performed between the shaft portion 31a of the first side gear 31 and the first sleeve 41 with the first washer 51 supported by the first washer support portion 61, so that the first washer 51 can be prevented from being wedged between the first side gear 31 and the first sleeve 41 in the press-fit coupling step. After the press-fit coupling has been completed, the back face 31gb of the first side gear 31 abuts against the first washer support portion 61, so that the first washer 51 can never be wedged between the first side gear 31 and the first sleeve 41 and the first washer 51 can be precisely supported.

Moreover, the first boss portion 10b1 of the differential case 10 has the first recess 11 formed in the inner end of the inner peripheral portion thereof. The first protrusion 81 capable of being engaged with the first recess 11 is formed integrally with the first sleeve 41 so as to be adjacent to the first washer support portion 61 and bulge outwardly in the radial direction further than the first washer support portion 61. The foregoing arrangement enables the engagement between the first protrusion 81 and the first recess 11 to prevent the first sleeve 41 from being removed from the differential case 10. The first protrusion 81 as removal prevention means cooperates with the first washer support portion 61 so as to serve also as support steadying means for the first washer 51. This further stabilizes the support for the first washer 51 on the first sleeve 41, while achieving a simplified structure. Meanwhile, the second side gear 32 has the second washer support portion 62 integrated therewith at the root of the shaft portion 32a thereof. The second washer support portion 62 has the outer peripheral surface 62a in which the inner peripheral portion 52i of the second washer 52 is fitted. The second washer support portion 62 further has the axial end face 62b against which the end face 42e on the front side in the press-fitting direction of the second sleeve 42 abuts. Thus, by the press-fit coupling P2, the second sleeve 42 can be coupled with the shaft portion 32a of the second side gear 32, while the second washer 52 is supported on the second washer support portion 62. Thus, the second washer 52 can be prevented from being wedged between the second side gear 32 and the second sleeve 42 in the press-fit coupling step. After the press-fit coupling has been completed, the end face 42e of the second sleeve 42 abuts against the second washer support portion 62, so that the second washer 52 can never be wedged between the second side gear 32 and the second sleeve 42 and the second washer 52 can be precisely supported.

Moreover, the second boss portion 10b2 of the differential case 10 has the second recess 12 formed in the inner end of the inner peripheral portion thereof. The second protrusion 82 capable of being engaged with the second recess 12 is provided in the second sleeve 42. The second washer support portion 62 is received together with the second protrusion 82 of the second sleeve 42 by the second recess 12 in the second boss portion 10b2. The foregoing arrangement enables the engagement between the second protrusion 82 and the second recess 12 to prevent the second sleeve 42 from being removed from the differential case 10. In addition, the second washer support portion 62 is also received by the second recess 12 in the second boss portion 10b2. Interference of the second washer support portion 62 with the differential case 10 can be easily avoided without allowing the structure to be complicated.

Additionally, by the press-fit coupling P1, the first sleeve 41 is coupled with the shaft portion 31a of the first side gear 31 under a condition in which the first washer 51 is placed and held on the first protrusion 81 of the first sleeve 41, and by the press-fit coupling P2, the second sleeve 42 is coupled with the shaft portion 32a of the second side gear 32 under a condition in which the second washer 52 is placed and held on the back face 32gb of the second side gear 32. Thus, the first and second side gears 31 and 32, the first and second sleeves 41 and 42, and the first and second washers 51 and 52 can be assembled in the differential case 10 quickly, while a predetermined holding attitude of the differential case 10 is maintained without the need to turn upside down the differential case 10 during the assembly work, so that assemblability can be further enhanced.

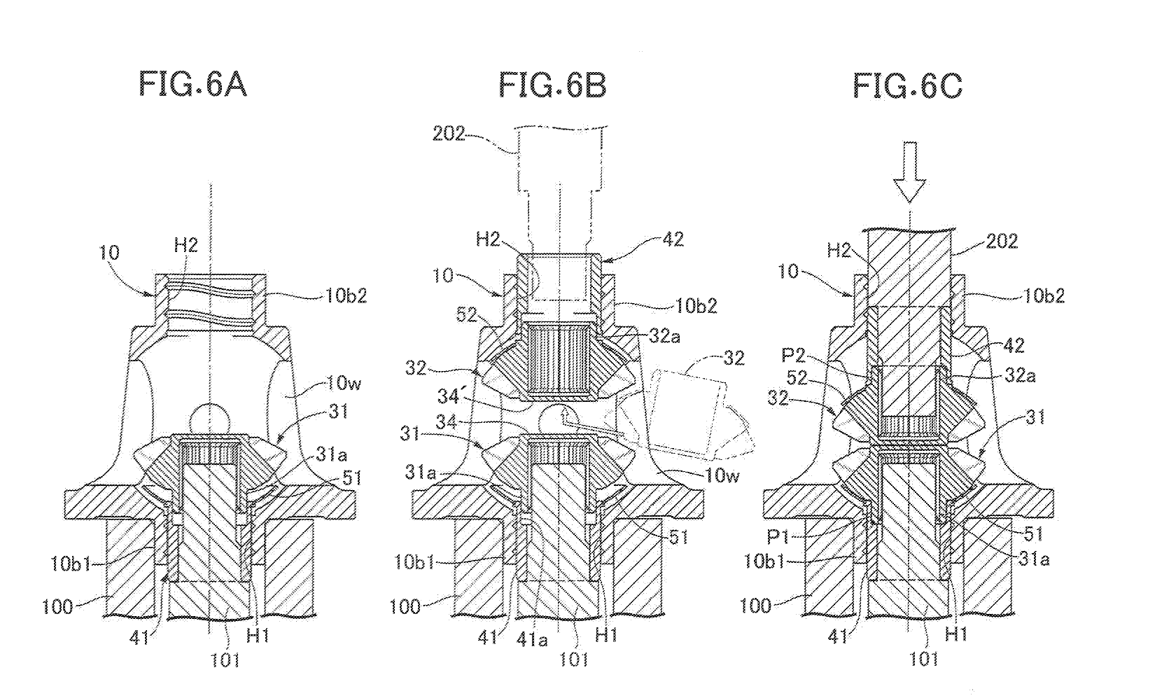

A second embodiment of the present invention will be described below with reference to FIGS. 6A to 6C. In the assembly processes of the first embodiment, the first sleeve press-fitting step in which by the press-fit coupling P1, the first sleeve 41 is coupled with the shaft portion 31a of the first side gear 31 and the second sleeve press-fitting step in which by the press-fit coupling P2, the second sleeve 42 is coupled with the shaft portion 32a of the second side gear 32 are performed independently of each other in sequence before the Pinion Gear Assembly Process (see FIG. 5) is performed. In contrast, in the second embodiment, the first sleeve press-fitting step and the second sleeve press-fitting step are performed at once before the Pinion Gear Assembly Process is performed.

Specifically, the assembly processes of the second embodiment include a first side gear unit assembly process, a second side gear unit assembly process, and a sleeve press-fitting process:

in the first side gear unit assembly process, the first side gear 31, the first sleeve 41, and the first washer 51 are inserted through the access window 10w into the differential case 10 to thereby be set at the respective predetermined positions (see FIG. 6A);

in the second side gear unit assembly process, the second side gear 32, the second sleeve 42, and the second washer 52 are inserted through the access window 10w into the differential case 10 to thereby be set at the respective predetermined positions (see FIG. 6B); and

in the sleeve press-fitting process, a first sleeve press-fitting step in which by the press-fit coupling P1, the first sleeve 41 is coupled with the shaft portion 31a of the first side gear 31 and a second sleeve press-fitting step in which by the press-fit coupling P2, the second sleeve 42 is coupled with the shaft portion 32a of the second side gear 32 are performed at once (see FIG. 6C).

In the above, the first side gear unit assembly process is performed through assembly steps identical to the assembly steps depicted in FIGS. 3A and 3B in the first embodiment. The second side gear unit assembly process is performed through assembly steps identical to the assembly steps depicted in FIG. 4A in the first embodiment. Under a condition in which the second side gear unit assembly process is completed (see FIG. 6B), the closing wall 34′ at the lower end of the second side gear 32 is abutted against and supported on the closing wall 34 at the upper end of the first side gear 31.

A differential device in the second embodiment is configured basically similarly to the differential device in the first embodiment and therefore, elements corresponding to those of the first embodiment are denoted by the same reference numerals. It should, however, be noted that, in the second embodiment, forms and sizes of the access window 10w, the first and second side gears 31 and 32, and the first and second sleeves 41 and 42 are set as appropriate so as to ensure that the first and second side gear unit assembly processes can be performed without hindrance.

In the sleeve press-fitting process, the second sleeve 42 is pressed toward the second side gear 32 side (that is, downwardly) under a condition in which the first sleeve 41 is supported by the first sleeve support base 101. The pressing force at this time is transmitted also to the first side gear 31 via the second side gear 32. The transmission of the pressing force results in both the press-fit coupling P2 between the second side gear 32 and the second sleeve 42 and the press-fit coupling P1 between the first side gear 31 and the first sleeve 41 being performed at once. It is noted that the first sleeve support base 101 and the second sleeve punch 202 are configured similarly to the first sleeve support base 101 and the second sleeve punch 202 used in the first embodiment.

Following the sleeve press-fitting process, the Pinion Gear Assembly Process (see FIG. 5) is performed through the steps identical to the assembly steps in the first embodiment.

The second embodiment can achieve effects basically identical to the effects achieved by the first embodiment. Additionally, in the second embodiment, the first sleeve press-fitting step and the second sleeve press-fitting step are performed at once. Thus, compared with the first embodiment in which the first sleeve press-fitting step and the second sleeve press-fitting step are performed independently of each other in sequence, the second embodiment shortens the assembly time and thus contributes to improved productivity.

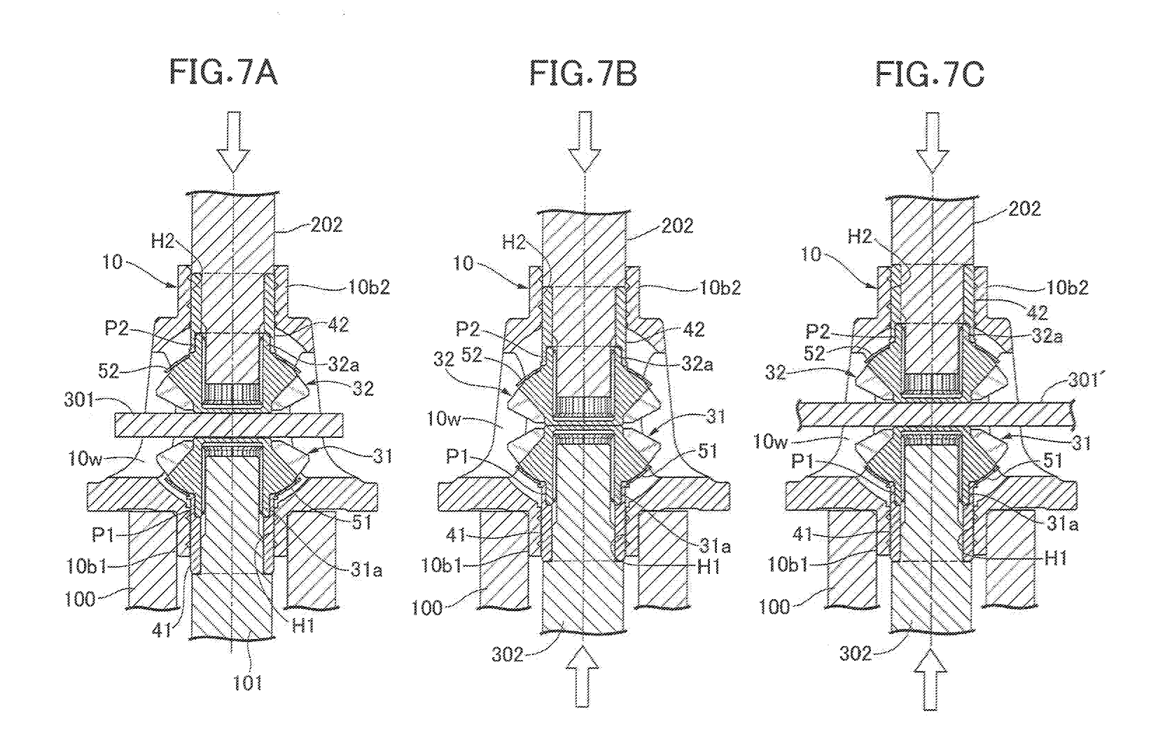

Variations 1 to 3 of the sleeve press-fitting process in the second embodiment (see FIG. 6C) will be described below in sequence with reference to FIGS. 7A to 7C.

In the sleeve press-fitting process in the second embodiment, under a condition in which the first sleeve 41 is supported from below by the stationary first sleeve support base 101 and the inner ends of the first and second side gears 31 and 32 are directly abutted against each other, the second sleeve 42 is pressed from above by the second sleeve punch 202. In variation 1 of the sleeve press-fitting process, the sleeve press-fitting process is performed under a condition in which an intervening element 301 in a free state (that is, being movable in an up-down direction) is disposed between the inner ends of the first and second side gears 31 and 32 as depicted in FIG. 7A, for example.

In variation 2 of the sleeve press-fitting process, the sleeve press-fitting process is performed such that as depicted in FIG. 7B, by using a first sleeve punch 302, for example, capable of being moved up and down by drive means (not depicted) instead of the stationary first sleeve support base 101, the first sleeve 41 is pressed from below by the first sleeve punch 302 and the second sleeve 42 is pressed from above by the second sleeve punch 202, at the same time. In this case, a tip portion of the first sleeve punch 302 is configured to have substantially the same form as the tip portion of the first sleeve support base 101.

In variation 3 of the sleeve press-fitting process, as depicted in FIG. 7C, the sleeve press-fitting process is performed under a condition in which an intervening element 301′ is disposed between the inner ends of the first and second side gears 31 and 32, by using the first and second sleeve punches 302 and 202 as in variation 2 of the sleeve press-fitting process described previously. In this case, the intervening element 301′ is fixed and supported by support means (not depicted) so as to be immovable at least during the performance of the sleeve press-fitting process.

Thus, variations 1 to 3 can also achieve effects identical to the effects achieved by the sleeve press-fitting process in the second embodiment (FIGS. 6A to 6C).

In the embodiments mentioned above, the first side gear 31 corresponds to the side gear or one of the side gears of the present invention, the second side gear 32 corresponds to the side gear or one of the side gears of the present invention, the first and second recesses 11 and 12 correspond to the recesses of the present invention, the first and second sleeves 41 and 42 correspond to the sleeves of the present invention, the first and second washers 51 and 52 correspond to the washers of the present invention, the first and second washer support portions 61 and 62 correspond to the washer support portions of the present invention, and the first and second protrusions 81 and 82 correspond to the protrusions of the present invention.

Embodiments of the present invention are explained above, but the present invention is not limited to the above-mentioned embodiments and may be modified in a variety of ways as long as the modifications do not depart from the gist of the present invention.

For example, in the embodiments described above, the differential device 1 is housed inside the transmission case 8 of the automobile, but the differential device 1 is not limited to the differential device for use in automobiles and can be carried out as differential devices for use in various types of machines and equipment. In the embodiments described above, the differential device 1 is applied to a right/left wheel transmission system and distributes power to the right and left drive shafts while permitting differential rotation therebetween. The differential device according to the present invention may nonetheless be applied to a front/rear wheel transmission system in a front/rear wheel drive vehicle and distributes power to the front and rear propeller shafts while permitting differential rotation therebetween.

The embodiments described above illustrate the pair of pinion gears 20 that is rotatably supported in the differential case 10 via the single pinion shaft 19 that is formed separately from the pinion gears 20 and that extends on one diameter line of the differential case 10. Three or more pinion gears 20 may nonetheless be rotatably supported in the differential case via respective three or more pinion shafts extending radially from a central portion of the differential case.

In the embodiments described above, the differential case 10 is an integrated differential case formed of a single seamless member. In the present invention, the differential case may nonetheless be an integrated differential case formed by unseparably combining a plurality of separate differential case elements into one substantially unitized body by coupling means such as welding and the like. Alternatively, the differential case may be formed by removably and integrally combining a plurality of separate differential case elements by coupling means such as bolts and the like.

In the embodiments described above, the pinion gears 20 and the first and second side gears 31 and 32 are each a bevel gear. In the present invention, the pinion gears 20 and the first and second side gears 31 and 32 may each be any type of gear other than the bevel gear, for example, a helical gear.

In the embodiments described above, the mutually opposing surfaces of the differential case 10 and the back faces 31gb and 32gb of the tooth portions 31g and 32g of the first and second side gears 31 and 32 are spherical. In the present invention, however, such mutually opposing surfaces may each be formed into a flat surface.

In the embodiments described above, the back face 31gb of the first side gear 31 is abutted against the first washer support portion 61 of the first sleeve 41. In the present invention, however, the back face 31gb of the first side gear 31 may face the first washer support portion 61 of the first sleeve 41 across a gap smaller than a wall thickness of the first washer 51.

In the embodiments described above, the end face 42e on the front side in the press-fitting direction of the second sleeve 42 is abutted against the second washer support portion 62 of the second side gear 32. In the present invention, however, the end face 42e of the second sleeve 42 may face the second washer support portion 62 of the second side gear 32 across a gap smaller than a wall thickness of the second washer 52.

In the embodiments described above, the second side gear support base 102 is supported by the plurality of struts 103 in the second sleeve press-fitting step. In the present invention, however, the second side gear support base 102 may be supported by a hollow cylindrical column having an inside diameter greater than an outside diameter of the flange 10f of the differential case 10.

What is claimed is:

1. A differential device, comprising:
a differential case;
pinion gears and a pair of side gears disposed in the differential case, the pinion gears and the side gears meshing with each other;
a cylindrical sleeve passing through the differential case and connected with at least one of the side gears; and
a washer disposed between a back face of a tooth portion of the one side gear and an inner surface of the differential case which face each other,
wherein the one side gear includes a shaft portion extending axially outwardly from the back face, the shaft portion and an inner peripheral surface of the sleeve being coupled with each other through a press-fit coupling, and
the one side gear has a washer support portion at a root of the shaft portion, the washer support portion having an outer peripheral surface thereof in which an inner peripheral portion of the washer is fitted, and the washer support portion having an axial end face thereof against which an end face on a front side in a press-fitting direction of the sleeve abuts or which the end face faces across a gap smaller than a wall thickness of the washer.

2. The differential device according to claim 1, wherein
the differential case has a through hole passing through and supporting the sleeve, the through hole having a recess formed at an inner end thereof,
the sleeve has a protrusion capable of being engaged in the recess, and
the washer support portion is received in the recess together with the protrusion.

3. A differential device, comprising:
a differential case;
pinion gears and a pair of side gears disposed in the differential case, the pinion gears and the side gears meshing with each other;
a cylindrical sleeve passing through the differential case and connected with at least one of the side gears; and
a washer disposed between a back face of a tooth portion of the one side gear and an inner surface of the differential case which face each other,
wherein the one side gear includes a shaft portion extending axially outwardly from the back face, the shaft portion and an inner peripheral surface of the sleeve being coupled with each other through a press-fit coupling, and
the sleeve includes a washer support portion disposed at an end portion on a front side in a press-fitting direction of the sleeve, the washer support portion having an outer peripheral surface thereof in which an inner peripheral portion of the washer is fitted, and the washer support portion having an axial end face thereof against which the back face of the one side gear abuts or which the back face faces across a gap smaller than a wall thickness of the washer.

4. The differential device according to claim 3, wherein
the differential case has a through hole passing through and supporting the sleeve, the through hole having a recess formed at an inner end thereof, and
the sleeve has a protrusion capable of being engaged in the recess, the protrusion being disposed to be adjacent to the washer support portion and to bulge radially outwardly further than the washer support portion.

5. A differential device, comprising:
a differential case;
pinion gears and first and second side gears disposed in the differential case, the pinion gears and the first and second side gears meshing with each other;
cylindrical first and second sleeves respectively passing through first and second boss portions of the differential case and connected with the respective first and second side gears; and
first and second washers respectively disposed between back faces of tooth portions of the first and second side gears and an inner surface of the differential case which face each other,
wherein the first and second side gears respectively include shaft portions extending axially outwardly from the back faces, the shaft portions and inner peripheral surfaces of the first and second sleeves being coupled with each other through press-fit couplings,
a first washer support portion and a first protrusion are provided at an end portion on a front side in a press-fitting direction of the first sleeve so as to be axially adjacent to each other, the first washer support portion having an outer peripheral surface thereof in which an inner peripheral portion of the first washer is fitted, the first washer support portion having an axial end face thereof against which the back face of the first side gear abuts or which the back face faces across a gap smaller than a wall thickness of the first washer, and the first protrusion bulging radially outwardly further than the first washer support portion, and
the second side gear has a second washer support portion at a root of the shaft portion of the second side gear, the second washer support portion having an outer peripheral surface thereof in which an inner peripheral portion of the second washer is fitted, and the second washer support portion having an axial end face thereof against which an end face on a front side in a press-fitting direction of the second sleeve abuts or which the end face faces across a gap smaller than a wall thickness of the second washer.

6. A method of assembling the differential device according to claim 5, comprising at least:
a case holding step of holding the differential case such that the second boss portion is on an upper side and the first boss portion is on a lower side;
a first sleeve assembling step of assembling the first sleeve in the differential case;
a first washer attaching step of fitting the first washer in the first washer support portion of the first sleeve and placing the first washer on the first protrusion;
a first side gear assembling step of assembling the first side gear in the differential case so as to be adjacent to an upper portion of the first sleeve;
a first sleeve press-fitting step of coupling the inner peripheral surface of the first sleeve with the shaft portion of the first side gear through the press-fit coupling;
a second sleeve assembling step of assembling the second sleeve in the differential case;
a second washer attaching step of fitting the second washer in the second washer support portion of the second side gear and placing the second washer on the back face of the second side gear;
a second side gear assembling step of assembling the second side gear in the differential case so as to be adjacent to a lower portion of the second sleeve; and
a second sleeve press-fitting step of coupling the inner peripheral surface of the second sleeve with the shaft portion of the second side gear through the press-fit coupling.
